(19) United States
(12) Patent Application Publication
(10) Pub. No.: US 2014/0015769 A1
(43) Pub. Date: Jan. 16, 2014

(54) TOUCH PANEL

(71) Applicant: SAMSUNG ELECTRO-MECHANICS CO., LTD., Suwon (KR)

(72) Inventors: Seung Min Lee, Suwon (KR); Sang Hwan Oh, Suwon (KR); Ho Joon Park, Suwon (KR); Wan Jae Lee, Suwon (KR)

(73) Assignee: Samsung Electro-Mechanics Co., Ltd., Suwon (KR)

(21) Appl. No.: 13/688,496

(22) Filed: Nov. 29, 2012

(30) Foreign Application Priority Data
Jul. 16, 2012 (KR) 10-2012-0077343

(51) Int. Cl. H01H 9/04

(52) U.S. Cl. CPC H01H 9/04
USPC 345/173; 200/302.1

(57) ABSTRACT

Disclosed herein is a touch panel including: a first substrate; a second substrate; a sensor provided between the first and second substrates and sensing a touch; and a sealing part provided at an edge between the first and second substrates to enclose the sensor and including micro-structured materials having a plate shaped structure.

### CROSS REFERENCE TO RELATED APPLICATION

This application claims the benefit of Korean Patent Application No. 10-2012-0077343, filed on Jul. 16, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a touch panel has been developed as an input device capable of inputting information such as text, graphics, or the like.

This touch panel is mounted on a display surface of an image display device such as an electronic organizer, a flat panel display device including a liquid crystal display (LCD) device, a plasma display panel (PDP), an electroluminescence (El) element, or the like, and a cathode ray tube (CRT) to thereby be used to allow a user to select desired information while viewing the image display device.

In addition, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

Meanwhile, in the touch panel according to the prior art, two transparent substrates on which transparent electrodes are formed are adhered to each other by an adhesive layer, as disclosed in the following Prior Art Document (Patent Document). However, the touch panel according to the prior art does not include a unit capable of sealing a boundary surface between the adhesive layer and the transparent substrate. Therefore, moisture or vapor may permeate into the touch panel through the boundary surface to change a physical property of an internal component such as the transparent electrode, or the like, such that reliability of the touch panel is deteriorated.

### PRIOR ART DOCUMENT

### Patent Document

(Patent Document 1) US20110234530 A1

### SUMMARY OF THE INVENTION

The present invention has been made in an effort to provide a touch panel capable of preventing moisture or vapor from permeating into a sensor sensing a touch by including a sealing part including micro-structured materials having a plate shaped structure.

According to a preferred embodiment of the present invention, there is provided a touch panel including: a first substrate; a second substrate; a sensor provided between the first and second substrates and sensing a touch; and a sealing part provided at an edge between the first and second substrates to enclose the sensor and including micro-structured materials having a plate shaped structure.

The sensor may include: a third substrate; electrode patterns formed on the third substrate; and electrode wirings formed on the third substrate so as to be connected to the electrode patterns.

The sensor may have an area narrower than that of the first or second substrate.

The micro-structured material may be nano clay.

The plate shaped structure of the micro-structured material may be extended in a direction that is in parallel with an exposed surface of the sealing part.

The first substrate may be a window.

The second substrate may be an anti-reflection (AR) film or a low-reflection (LR) film.

The second substrate may be a display.

The first substrate and the sensor may be adhered to each other by a first adhesive layer.

The first adhesive layer may be an optical clear adhesive (OCA).

The second substrate and the sensor may be adhered to each other by a second adhesive layer.

The second adhesive layer may be an optical clear adhesive (OCA).

### BRIEF DESCRIPTION OF THE DRAWINGS

The above and other objects, features and advantages of the present invention will be more clearly understood from the following detailed description taken in conjunction with the accompanying drawings, in which:

FIGS. 1 to 3 are cross-sectional views of a touch panel according to a preferred embodiment of the present invention;

FIG. 4 is a conceptual diagram of a sealing part shown in FIG. 1;

FIG. 5 is a view showing a chemical structural formula of nano clay; and

FIG. 6 is a view showing a plate shaped structure of the nano clay.

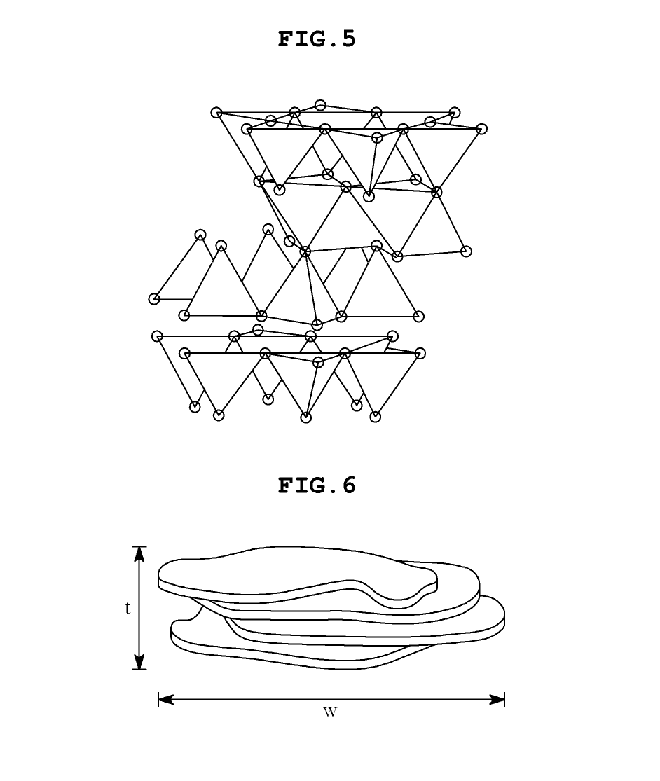

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

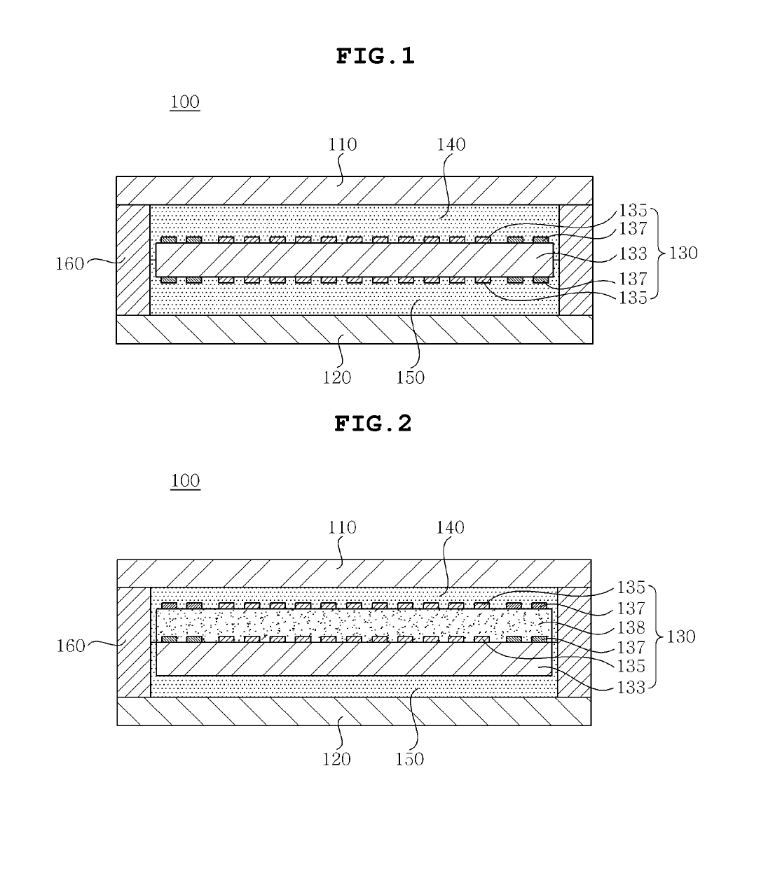

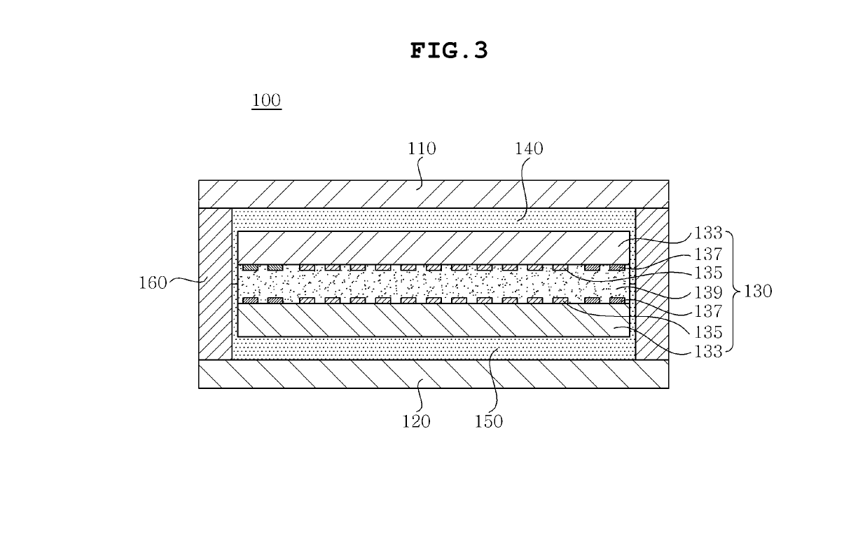

FIGS. 1 to 3 are cross-sectional views of a touch panel according to a preferred embodiment of the present invention; and FIG. 4 is a conceptual diagram of a sealing part shown in FIG. 1.

As shown in FIGS. 1 to 3, the touch panel 100 according to the present embodiment is configured to include a first substrate 110, a second substrate 120, a sensor 130 provided between the first and second substrates 110 and 120 and sensing a touch, and a sealing part 160 provided at an edge between the first and second substrates 110 and 120 to enclose the sensor 130 and including micro-structured materials 165 having a plate shaped structure.

The first substrate 110 may be a window provided an upper side of the sensor 130, which is the outermost side of the touch panel 100. In the case in which the first substrate 110 is the window, an exposed surface of the first substrate 110 has transparency so that it may receive a touch of a user and allow the user to recognize an image provided on a display. Here, the first substrate 110 may be made of glass, tempered glass, or the like, but is not necessarily limited thereto.

The second substrate 120 may be an anti-reflection (AR) film or a low-reflection (LR) film provided at a lower side of the sensor 130. Here, the AR film serves to prevent reflection of light, and the LR film serves to reduce the reflection of the light. However, the second substrate 120 needs not necessarily be the AR film or the LR film, but may be a display providing an image. In addition, the second substrate 120 may be any component capable of being provided at the lower side of the sensor 130 in the touch panel 100, such as a polymer film, glass, or the like.

The sensor 130, which serves to sense the touch, is provided between the first and second substrates 110 and 120. Here, the sensor 130 may be adhered to the first substrate 110 by a first adhesive layer 140 and be adhered to the second substrate 120 by a second adhesive layer 150. Here, each of the first and second adhesive layers 140 and 150 may be an optical clear adhesive (OCA). In addition, the sensor 130 may include a third substrate 133, electrode patterns 135 formed on the third substrate 133, and electrode wirings 137 formed on the third substrate 133 so as to be connected to the electrode patterns 135. More specifically, the third substrate 133 serves to provide a region on which the electrode patterns 135 and the electrode wirings 137 are to be formed.

Here, the third substrate 133 needs to have support force capable of supporting the electrode patterns 133 and the electrode wirings 137 and transparency capable of allowing the user to recognize the image provided by the display In consideration of the support force and the transparency described above, the third substrate 133 may be made of polyethylene terephthalate (PET), polycarbonate (PC), poly methyl methacrylate (PMMA), polyethylene naphthalate (PEN), polyethersulfone (PES), a cyclic olefin polymer (COC), a triacetylcellulose (TAC) film, a polyvinyl alcohol (PVA) film, a polyimide (PI) film, polystyrene (PS), biaxially oriented polystyrene (BOPS; containing K resin), glass, tempered glass, or the like, but is not necessarily limited thereto.

In addition, the electrode patterns 135 serve to generate a signal at the time of the touch of the user, thereby allowing a controller to recognize a touch coordinate. Here, the electrode patterns 135 may be formed in a mesh pattern using copper (Cu), aluminum (Al), gold (Au), silver (Ag), titanium (Ti), palladium (Pd), chromium (Cr), or a combination thereof. In this case, the electrode patterns 135 may be formed by a plating process or a depositing process using a sputter. Further, in the case in which the electrode patterns 135 are made of copper (Cu), surfaces of the electrode patterns 135 may be black-oxide treated. As described above, the surfaces of the electrode patterns 135 are black-oxide treated to prevent light from being reflected, thereby making it possible to improve visibility of the touch panel 100. Meanwhile, the electrode patterns 135 may also be formed using metal silver formed by exposing/developing silver salt emulsion layer, a metal oxide such as an indium thin oxide (ITO), or the like, a conductive polymer such as poly-3, 4-ethylenedioxythiophene/polystyrenesulfonate (PEDOT/PSS), or the like, having excellent flexibility and a simple coating process. Meanwhile, the electrode patterns 135 may be formed in all patterns known in the art, such as a planar rod shaped pattern, a diamond pattern, a rectangular pattern, a triangular pattern, circular pattern, and the like.

In addition, the electrode wirings 137 are connected to the electrode patterns 135 to serve to transmit/receiving electrical signals to/from the electrode patterns 135. Here, the electrode wirings 137 are formed integrally with the electrode patterns 135, thereby making it possible to simplify a manufacturing process and reduce a lead time.

Meanwhile, the third substrate 133, the electrode patterns 135, and the electrode wirings 137 may be configured in various shapes. For example, as shown in FIG. 1, the electrode patterns 135 and the electrode wirings 137 may be formed on both surfaces of a single third substrate 133. Alternatively, as shown in FIG. 2, after the electrode patterns 135 and the electrode wirings 137 are formed on the third substrate 133, an insulating layer 138 may be formed on the third substrate 133 and the electrode patterns 135 and the electrode wirings 137 may be again formed on the insulating layer 138. In addition, as shown in FIG. 3, after the electrode patterns 135 and the electrode wirings 137 are formed on each of the two third substrates 133, a spacer 139 may be disposed between the two third substrates 133. Although a type of the sensor 130 shown in FIGS. 1 to 3 is based on a capacitive type, a type of the sensor 130 according to the preferred embodiment of the present invention is not limited to the capacitive type, but may be all types known in the art, such as a resistive type, and the like.

As described above, the first and second substrates 110 and 120 include the sensor 130 provided therebetween, wherein the sensor 130 includes the electrode patterns 135 sensing the touch, the electrode wirings, and the like. Therefore, when moisture or vapor permeates into the sensor 130, physical properties of the electrode patterns 135, the electrode wirings 137, or the like, are changed, such that reliability of the touch panel 100 may be deteriorated. However, the touch panel 100 according to the present embodiment includes the sealing part 160 to prevent the permeation of the moisture or the vapor. A detailed description thereof will be provided below.

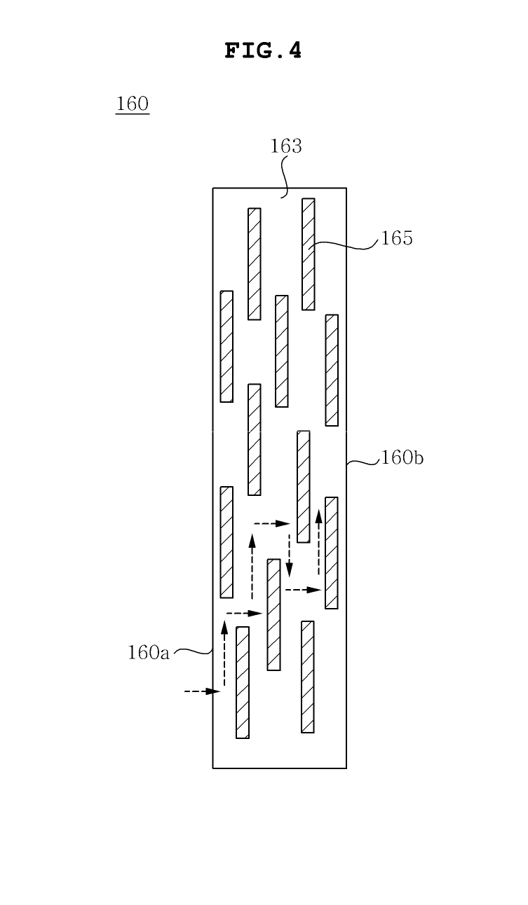

The sealing part 160 is provided at the edge between the first and second substrates 110 and 120 to enclose the sensor 130, thereby serving to prevent the moisture or the vapor from permeating into the sensor. Here, the sensor 130 may be formed to have an area narrower than that of the first or second substrate 110 or 120 so that the sealing part 160 may completely enclose the sensor 130. Meanwhile, the sealing part 160 includes the micro-structured materials 165, as shown in FIG. 4. More specifically, the micro-structured materials 165 may be dispersed in a polymer material 163 to form the sealing part 160. Here, the micro-structured material 165 may be nano clay 165 excellent having gas/liquid barrier properties. The nano clay 165 may be formed so as to be stacked as layers, have a chemical structural formula as shown in FIG. 5, and have a plate shaped structure in which it has a width (w) larger than a thickness t in a micro unit. Therefore, as shown in FIG. 4, when the sealing part 160 is formed by dispersing the nano clay 165 in the polymer material 163, a permeation path of the moisture or the vapor from an exposed surface 160a of the sealing part 160 to an inner surface of the sealing part 160b becomes long by the nano clay 165 having the plate shaped structure (See an arrow of FIG. 4). As a result, blocking efficiency of the moisture or the vapor permeating into the sensor 130 is increased, thereby making it possible to secure reliability of the touch panel 100. Here, in order to increase the permeation path of the moisture or the vapor as much as possible, the plate shaped structure of the nano clay 165 may be extended in a direction that is substantially in parallel with the exposed surface 160a of the sealing part, which is a direction vertical to a path through which the moisture or the vapor initially permeates (that is, the exposed surface 160a of the sealing part 160 and a width direction of the nano clay 165 are in parallel with each other). Meanwhile, a method of forming the sealing part 160 by dispersing the nano clay 165 in the polymer material 163 is not particularly limited. For example, the sealing part 150 may be formed by dispersing the nano clay 165 in the polymer material 163 and then performing molding using a hot-press or adding a photoinitiator thereto and then performing ultraviolet curing. In addition, an example of the nano clay 165 may include synthetic silicate, montmorillonite (MMT), synthetic mica, nonronite, or the like, and an example of the polymer material 163 in which the nano clay 165 is disposed may include nylon 6 (PA6), PAMXD6, PMDA based polyimide (PI), poly vinyl chloride (PVC), polyethyleneterephthalate (PET), or the like, but is not limited thereto.

As set forth above, the touch panel according to the preferred embodiment of the present invention includes the sealing part including the micro-structured materials having the plate shaped structure to prevent the moisture or the vapor from permeating into the sensor, thereby making it possible to secure the reliability of the touch panel.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a first substrate;
a second substrate;
a sensor provided between the first and second substrates and sensing a touch; and
a sealing part provided at an edge between the first and second substrates to enclose the sensor and including micro-structured materials having a plate shaped structure.

2. The touch panel as set forth in claim 1, wherein the sensor includes:
a third substrate;
electrode patterns formed on the third substrate; and
electrode wirings formed on the third substrate so as to be connected to the electrode patterns.

3. The touch panel as set forth in claim 1, wherein the sensor has an area narrower than that of the first or second substrate.

4. The touch panel as set forth in claim 1, wherein the micro-structured material is nano clay.

5. The touch panel as set forth in claim 1, wherein the plate shaped structure of the micro-structured material is extended in a direction that is in parallel with an exposed surface of the sealing part.

6. The touch panel as set forth in claim 1, wherein the first substrate is a window.

7. The touch panel as set forth in claim 1, wherein the second substrate is an anti-reflection (AR) film or a low-reflection (LR) film.

8. The touch panel as set forth in claim 1, wherein the second substrate is a display.

9. The touch panel as set forth in claim 1, wherein the first substrate and the sensor are adhered to each other by a first adhesive layer.

10. The touch panel as set forth in claim 9, wherein the first adhesive layer is an optical clear adhesive (OCA).

11. The touch panel as set forth in claim 1, wherein the second substrate and the sensor are adhered to each other by a second adhesive layer.

12. The touch panel as set forth in claim 11, wherein the second adhesive layer is an optical clear adhesive (OCA).
